(19) United States
(12) Patent Application Publication
(10) Pub. No.: US 2006/0132696 A1
(43) Pub. Date: Jun. 22, 2006

(54) Liquid crystal display

(75) Inventors: Te-Sheng Chen, Jhubei City (TW); Kuan-Cheng Lee, Sinjhuang City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/099,300

(22) Filed: Apr. 5, 2005

(30) Foreign Application Priority Data
Dec. 17, 2004 (TW) 93139570

(51) Int. Cl. G02F 1/1339

(52) U.S. Cl. 349/153

(57) ABSTRACT

A liquid crystal display including a first substrate, a second substrate and a non-transparent sealant is provided. The second substrate is disposed opposite to the first substrate, and the non-transparent sealant is cured on the peripheral surface of the second substrate. The non-transparent sealant is adhered to the first substrate while the first substrate and the second substrate are assembled together. The inspector can easily determine whether the plastering of sealant is complete or breakage occurs. Meanwhile, the low-temperature vacuum bubble occurs can be reduced during the display panel manufacturing process

This application claims the benefit of Taiwan application Serial No. 93139570, filed Dec. 17, 2004, the subject matter of which is incorporated herein by reference.

### BACKGROUND OF THE INVENTION

1. Field of the Invention

The invention relates in general to a display panel, and more particularly to a display panel with non-transparent sealant.

2. Description of the Related Art

The thin film transistor Liquid crystal display (TFT-LCD) has gained popularity among high-level products due to the features of high luminance and wide viewing angle. A conventional TFT-LCD comprises a TFT substrate, a color filter substrate and a liquid crystal disposed between the TFT substrate and the color substrate. The color filter substrate comprises a common electrode, a color filter, an upper alignment film and a black matrix (BM). The TFT substrate comprises a plurality of scan lines, a plurality of data lines, a plurality of storage capacitors, a plurality of TFTs, a plurality of pixel electrodes, and at least one alignment film. Besides, using spacers to maintain an interval between the TFT substrate and the color filter substrate enables the liquid crystal to be sealed at the interval between the TFT substrate and the color filter substrate. Besides, the TFT substrate and the color filter substrate are assembled together by the use of sealant.

One drop filling (ODF) method has gradually become the mainstream manufacturing method in the manufacturing process of liquid crystal display panel. In the ODF manufacturing process, firstly, the peripheral surface of the substrate is dispensed with sealant such as ultraviolet glue for instance. Next, liquid crystals drop onto the surface of the TFT substrate and enclosed by the sealant. Then, the TFT substrate and the color filter substrate are assembled in vacuum. Lastly, light is projected onto the sealant and the sealant is solidified.

The sealant is normally cured on the flange of the black matrix, and the light is projected from the color filter substrate to solidify the sealant. Therefore the sealant can have a complete response to the light and the liquid crystal or the TFT would not be damaged by ultraviolet light. However, in the application of a small-sized liquid crystal display panel, a mobile phone for instance, the sealant would be cured under the black matrix. If the light is projected onto the sealant from the color filter, the sealant might not be able to achieve complete solidification, thereby causing Mura on the peripheral of the panel. Therefore, the light must be projected onto the sealant from the side of the TFT substrate.

Due to the layout design of having a metallic wire, such as a scan line or a data line, disposed on the TFT substrate, part of the sealant would be positioned under the metallic wire. If the metallic wire were too wide, the ultraviolet light would not be able to fully solidify the sealant. Besides, when the light is projected onto the sealant from the TFT substrate, the liquid crystal or the TFT would be jeopardized or would have current leakage if the exposure of the ultraviolet light is too high or the wavelength of the wave-length is too short.

Referring to FIG. 1, a side view of the sealant cured on a conventional panel is shown. The liquid crystal display panel comprises a first substrate 101, a second substrate 102, a transparent sealant 104, a liquid crystal 105 and a black matrix 103. The first substrate 101 is a color filter substrate. According to the conventional practice, the black matrix 103 is directly connected to the first substrate 101. By doing so, not only the transparent sealant 104 would be blocked the projection of light by the black matrix 103, but also the problem of insufficient adherence between the black matrix 103 and the first substrate 101 would occur. Meanwhile, during the process of manufacturing display panels, low-temperature vacuum bubbles or air bubbles occupying the space among liquid crystal particles would occur and largely affect the quality of the product.

After the sealant is cured, the inspector would determine whether the curing of the sealant comply with the standard via visual inspection or the use of optical apparatus. Since conventional sealant is transparent, it becomes difficult for the inspector to inspect the curing of the sealant determine whether the curing of the sealant comply with the standard via visual inspection or the use of optical apparatus when the curing is too delicate or too rough, or when breakage or incomplete curing occurs. Consequently, the quality of sealant inspection would be largely affected.

### SUMMARY OF THE INVENTION

It is therefore an object of the invention to provide sealant which is easy for inspection. The sealant can be cured by the exposure from the side of the color filter substrate, so that the inspector can easily determine whether the plastering of sealant is complete or breakage occurs. Meanwhile, the low-temperature vacuum bubble occurs can be reduced during the display panel manufacturing process, the manufacturing process pass-rate and quality of product would be improved, and the competitive capacity of the display panel and business can be enhanced.

According to the present invention, a display panel comprising a first substrate, a second substrate and a non-transparent sealant is provided. The second substrate is disposed opposite to the first substrate, while the non-transparent sealant is disposed between the first substrate and the second substrate and cured on the peripheral surface of the second substrate, wherein the non-transparent sealant contains at least one colored material.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a side view of the sealant cured on a conventional panel;

FIG. 2A is a side view of a display panel according to the first embodiment of the invention;

FIG. 2B is a schematic diagram showing the sealant of the first embodiment cured on the second substrate;

FIG. 3A is a side view of the second embodiment of the invention;

FIG. 3B is a schematic diagram showing the sealant cured on the second substrate;

FIGS. 3C˜3E are schematic diagrams of various extension structures positioned on the second substrate;

FIG. 4A is a schematic diagram showing the division of a substrate; and

FIG. 4B is a partial schematic diagram of a first substrate 400a.

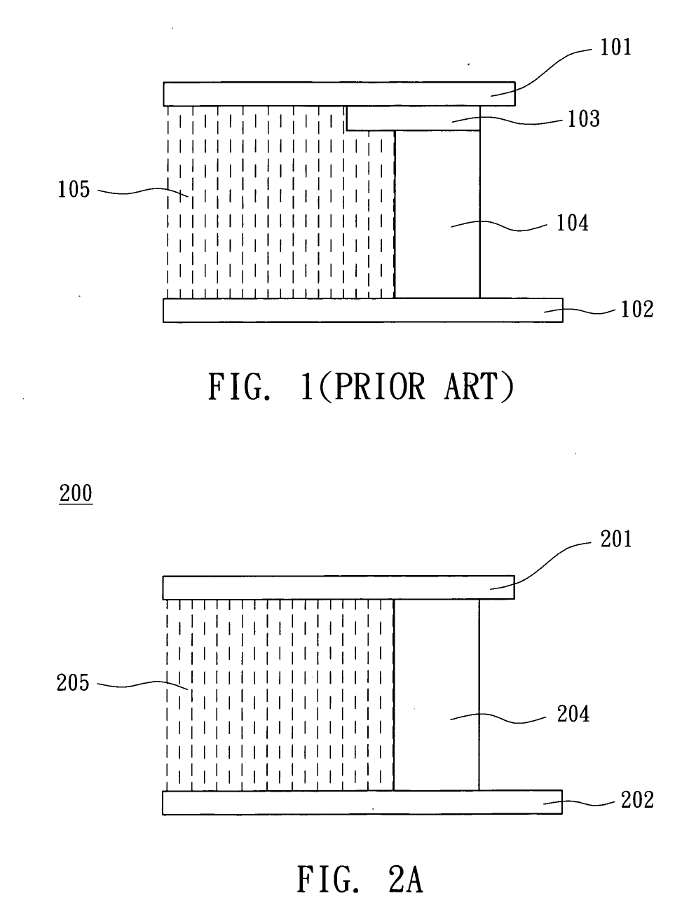

### DETAILED DESCRIPTION OF THE INVENTION

### First Embodiment

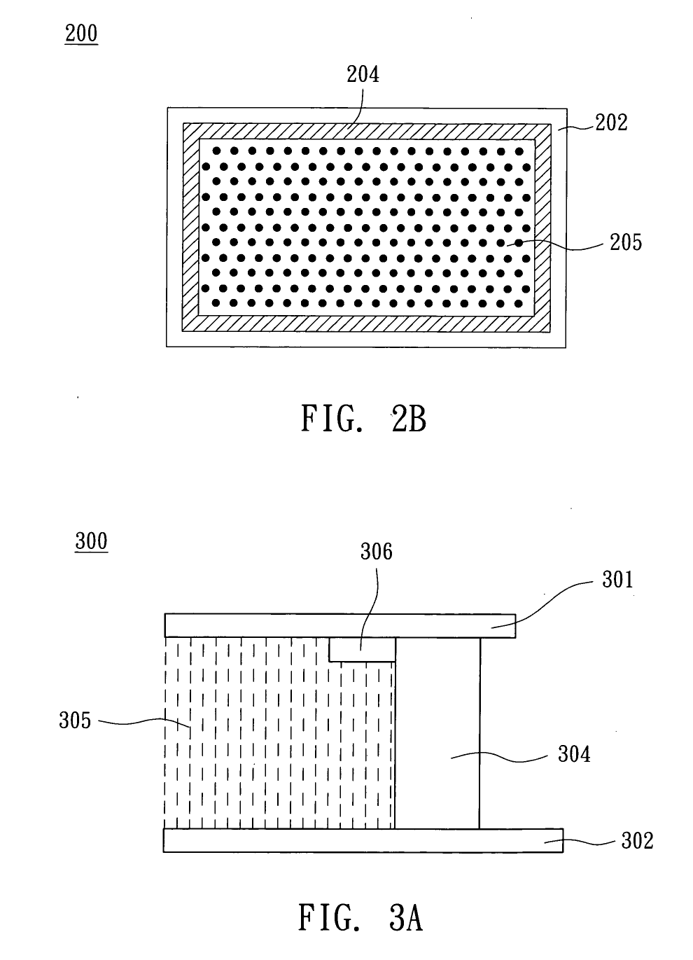

Referring to FIG. 2A, a side view of a display panel according to the first embodiment of the invention is shown. In FIG. 2A, display panel 200 comprises a first substrate 201, a second substrate 202 and non-transparent sealant 204. The first substrate 201 and the second substrate 202 respectively can either be a color filter substrate and a TFT substrate, or a TFT substrate and a color filter substrate. The non-transparent sealant 204 is normally an ultraviolet (UV) resin, a thermal resin, or a mixture of the UV resin and the thermal resin. The second substrate 202 is disposed opposite to the first substrate 201 in parallel. Referring to FIG. 2B, a schematic diagram showing the sealant of the first embodiment cured on the second substrate is shown. As shown in FIG. 2B, the non-transparent sealant 204 is cured on the peripheral surface of the second substrate 202 and is adhered to the first substrate 201 when the first substrate 201 and the second substrate 202 are assembled together. The liquid crystal 205 is sealed between the first substrate 201 and the second substrate 202.

In the present embodiment, the non-transparent sealant 204 contains pigment, dye, or a mixture of pigment and dye. Besides, the non-transparent sealant 204, which can block the light and displace the black matrix positioned on the peripheral of the panel, can comprise carbon black, black dye or black pigment. The color of the non-transparent sealant 204 can be red, blue, green or dark. When the display panel is normally white under normal circumstances, a TN display panel for example, or when the optical axes of upper and lower polarizers, wherein the display panel is sandwiched in between the upper and lower polarizers, are substantially parallel, the optical density (OD value) of the non-transparent sealant 204 has to be larger than or equal to 3. When the display panel is d normally black under normal circumstances, an MVA or an IPS display panel for example, or when the optical axes of upper polarizer and lower polarizer, wherein the display panel is sandwiched in between the upper and lower polarizers, are substantially crossed, the optical density (OD value) of the non-transparent sealant 204 has to be larger than or equal to 2.

### Second Embodiment

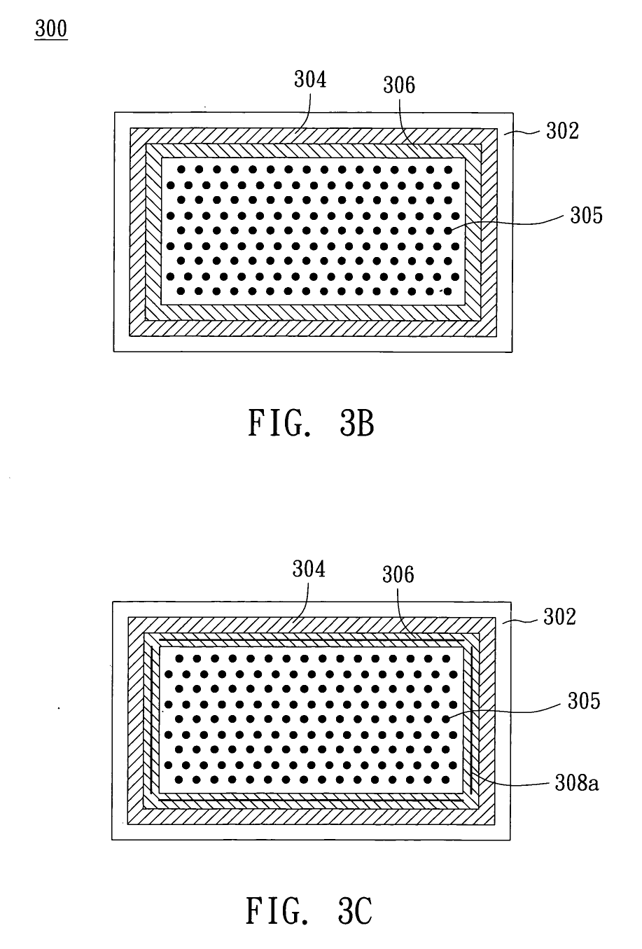

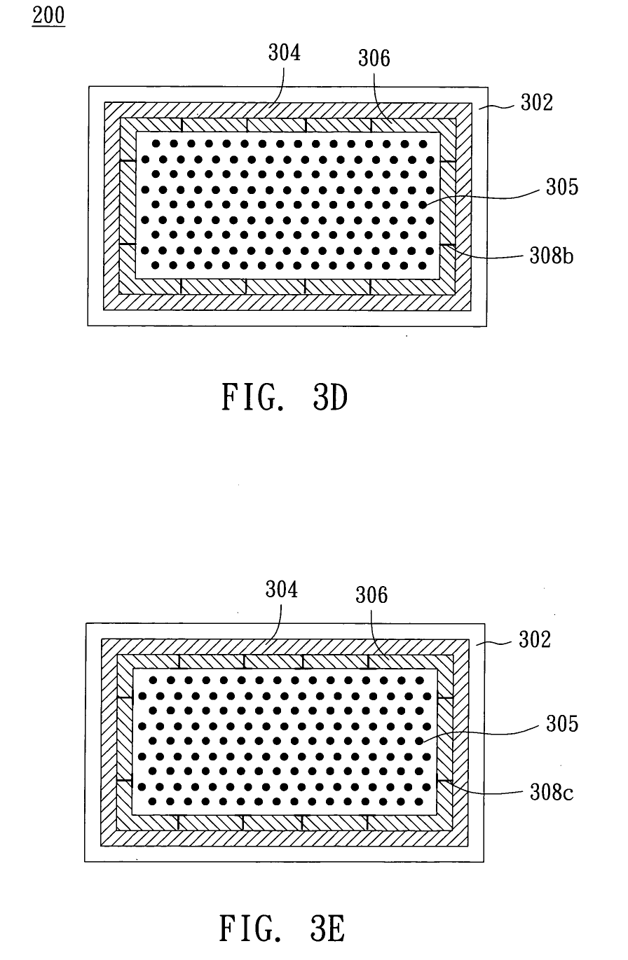

Refer to FIG. 3A and FIG. 3B. FIG. 3A is a side view of the second embodiment of the invention. Display panel 300 comprises a first substrate 301, a second substrate 302, non-transparent sealant 304 and black matrix positioned on the peripheral of the panel 306. The second substrate 302 is disposed opposite to the first substrate 301, and the non-transparent sealant 304 is cured on the peripheral surface of the second substrate 302 and is adhered to the first substrate 301 when the first substrate 301 and the second substrate 302 are assembled together. The liquid crystal 305 is sealed between the first substrate 301 and the second substrate 302. The non-transparent sealant 304 has the same constituent with the non-transparent sealant 204 disclosed in the first embodiment. The black matrix positioned on the peripheral of the panel 306 is formed on the surface of the second substrate 302 and is enclosed by the non-transparent sealant 304.

In the present embodiment, the optical densities of the non-transparent sealant 304 and the black matrix positioned on the peripheral of the panel 306 are substantially the same. Besides, the color of the non-transparent sealant 304 can be different from that of the black matrix positioned on the peripheral of the panel 306. For example, the non-transparent sealant 304 can be red, green blue or dark, so that the inspector can easily differentiate the black matrix positioned on the peripheral of the panel 306 from the non-transparent sealant 304 and determine whether is incomplete curing or breakage occurs while the non-transparent sealant 304 is cured.

The non-transparent sealant 304 is normally cured on the second substrate 302 by a spray nozzle or using screen-printing technology, so unevenness would occur to the peripheral surface of the non-transparent sealant 304. To make the part of the non-transparent sealant 304 near the central part of the display panel 300 to be smoother, the present embodiment adopts a very narrow black matrix positioned on the peripheral of the panel 306 or spacers (not shown in the figure) to smooth the non-transparent sealant 304.

To resolve the problem of generating low-temperature vacuum bubble that would occur to a conventional display panel, the present embodiment includes a design of an extension structure disposed in the display panel 300 as shown in FIGS. 3C˜3D. In FIG. 3C, an extension structure 308a is disposed between the first substrate 301 and the second substrate 302 of FIG. 3A in parallel and is enclosed by the non-transparent sealant 304. The extension structure 308a can be disposed on the second substrate 302 or the first substrate 301 of FIG. 3A and embedded into the liquid crystal 305 when the liquid crystal 305 is sealed by the first substrate 301 and the second substrate 302. As shown in FIG. 3D, an extension structure 308b is connected to the non-transparent sealant 304. As shown in FIG. 3E, a T-shaped extension structure 308c is connected to the non-transparent sealant 304.

Low-temperature vacuum bubbles or air bubbles occurred to the display panel would be moved to the edges when the panel is tipped or tapped. Moreover, the vacuum bubbles would enter into the space formed among the non-transparent sealant 304 and any of the extension structures 308a, 308b and 308c, and would not gather around the central part of the display panel 300.

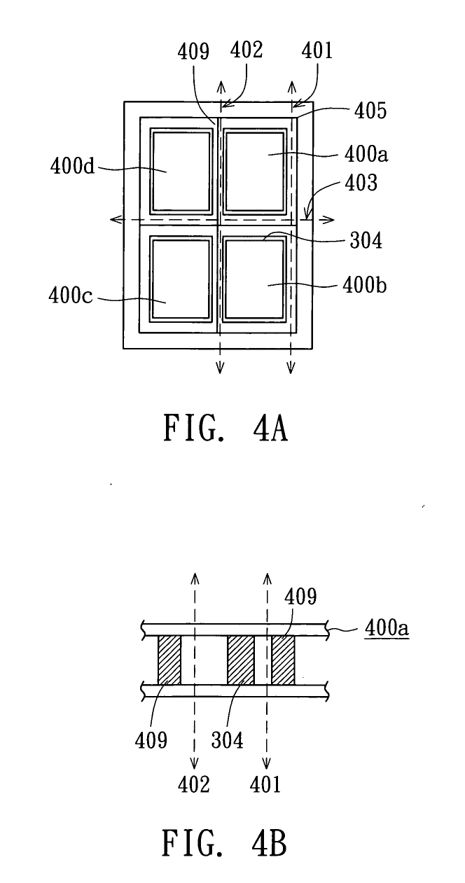

Referring to both FIG. 4A and FIG. 4B, wherein FIG. 4A is a schematic diagram showing the division of a substrate and FIG. 4B is a partial schematic diagram of a first substrate 400a. The first substrates 400a, 400b, 400c and 400d are obtained by dividing a large substrate 405. The cutting lines can be cutting lines 401, 402 and 403. The non-transparent sealant 304 is the main sealant enabling the first substrate 400a and the second substrate to be adhered together, while a dummy seal 409 disposed to the periphery of the non-transparent sealant 304 is to assist and enhance the adherence between the two substrates.

The first embodiment is applicable to both large-sized and small-sized panels. Containing a colored dye or pigment, the non-transparent sealant displaces the conventional black matrix positioned on the peripheral of the panel. Particularly in a small-sized panel, the sealant will no longer be blocked by the black matrix and will be fully exposed to the shining of the light, so sealant solidification and product quality can be further improved.

In the second embodiment, if a large-sized panel comprises a black matrix positioned on the peripheral of the panel and an easy inspection is desired, the color of non-transparent sealant can be different from that of the black matrix for the inspector to easily differentiate the sealant from the black matrix when inspecting the sealant.

The second embodiment, as shown in FIGS. 3C˜3E, further disposes an extension structure on the second substrate for the vacuum bubbles generated during the panel manufacturing process to be contained within the space enclosed by the extension structure so that the display region of the display panel can be increased. Therefore, the method of the first embodiment and the second embodiment not only enhance the adherence between the substrates. Meanwhile, the design of making the color of the black matrix positioned on the peripheral of the panel to be different from that of the non-transparent sealant enables the inspector to easily differentiate the black matrix positioned on the peripheral of the panel from the non-transparent sealant when inspecting the curing of the sealant. Besides, the design of adopting an extension structure prevents the low-temperature vacuum bubbles from gathering around the center of the panel, lest part of display region might be incapacitated. Thereby, the design of the invention not only improves the competitive power of the business but also increases the core value of the product.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display panel, comprising:
a first substrate;
a second substrate, disposed opposite to the first substrate; and
a non-transparent sealant, disposed between the first substrate and the second substrate, cured on the peripheral surface of the second substrate, wherein the non-transparent sealant contains at least one colored material.

2. The display panel according to claim 1, wherein the colored material is a pigment.

3. The display panel according to claim 1, wherein the colored material is a dye.

4. The display panel according to claim 1, wherein the colored material is carbon black.

5. The display panel according to claim 1, wherein the optical density of the non-transparent sealant is larger than or equal to 2.

6. The display panel according to claim 5, wherein the optical density of the non-transparent sealant is larger than or equal to 3.

7. The display panel according to claim 1, further comprising an extension structure disposed between the first substrate and the second substrate in parallel and enclosed by the non-transparent sealant.

8. The display panel according to claim 7, wherein the extension structure is T-shaped.

9. The display panel according to claim 1, wherein the non-transparent sealant is an ultraviolet resin.

10. The display panel according to claim 1, wherein the non-transparent sealant is a thermal resin.

11. The display panel according to claim 1, wherein the non-transparent sealant is a mixture of UV resin and thermal resin.

12. The display panel according to claim 1, wherein the first substrate is a TFT substrate and the second substrate is a color filter substrate.

13. The display panel according to claim 1, wherein the first substrate is a color filter substrate and the second substrate is a TFT substrate.

14. The display panel according to claim 1, further comprising a dummy seal disposed between the first substrate and the second substrate, and on the periphery of the non-transparent sealant.

15. The display panel according to claim 12, further comprising a black matrix positioned on the peripheral of the second substrate, wherein the black matrix is formed on the surface of the second substrate and enclosed by the non-transparent sealant.

16. The display panel according to claim 15, wherein the non-transparent sealant comprises a pigment or a dye.

17. The display panel according to claim 15, wherein the color of the non-transparent sealant differs from the color of the black matrix.
